(19) United States
(12) Patent Application Publication
(10) Pub. No.: US 2024/0171419 A1
(43) Pub. Date: May 23, 2024

(54) ADAPTATION OF PARALLEL CONVERSATIONS IN THE METAVERSE

(71) Applicant: INTERNATIONAL BUSINESS MACHINES CORPORATION, ARMONK, NY (US)

(72) Inventors: Jeremy R. Fox, Georgetown, TX (US); Jessica Nahulan, Markham (CA); Carolina Garcia Delgado, Zapopan (MX); Tiberiu Suto, Franklin, NY (US)

(21) Appl. No.: 18/058,287

(22) Filed: Nov. 23, 2022

(51) Int. Cl. H04L 12/18; G06T 13/40

(52) U.S. Cl. CPC H04L 12/1822; G06T 13/40

(57) ABSTRACT

According to one embodiment, a method, computer system, and computer program product for parallel conversation management in a virtual environment is provided. The present invention may include monitoring conversations between one or more users; detecting differences in the conversations between the one or more users; generating one or more conversation subgroups based on the detected differences in the conversations; and grouping the one or more users into the one or more conversation subgroups.

### BACKGROUND

The present invention relates, generally, to the field of computing, and more particularly to the metaverse.

The metaverse is a hypothetical iteration of the internet as a single, universal and immersive virtual world. The metaverse is built on the convergence of virtual reality (VR) and augmented reality (AR), which allows for a web of networked immersive experiences and social in multiuser persistent platforms. Currently, collaboration, social interaction, and dialogue between persons are possible within the metaverse. However, for a seamless conversational experience to occur which replicates that of an in-person group meetup, the metaverse needs a way to support real-world group gathering dynamics, such as a group conversation turning into two parallel smaller group conversations, and then turning back into one group conversation. Organic conversation dynamics are an essential factor in both developing a social connection and collaboration, and greatly impact a user's experience in the metaverse.

### SUMMARY

Embodiments of a method, a computer system, and a computer program product are described. According to one embodiment, a method, computer system, and computer program product for parallel conversation management in a virtual environment is provided. The present invention may include monitoring conversations between one or more users. The present invention may include detecting differences in the conversations between the one or more users. The present invention may include generating one or more conversation subgroups based on the detected differences in the conversations. The present invention may include grouping the one or more users into the one or more conversation subgroups. A permissive embodiment of the present invention may include displaying at least one customized visual representation to the one or more users depicting other users' statuses and/or privacy settings of other conversation subgroups. A permissive embodiment of the present invention may include employing an artificial intelligence system that monitors and understands one or more ongoing conversations. A permissive embodiment of the present invention may include permitting the one or more users to join and/or switch between the one or more separate conversation subgroups, when appropriate. A permissive embodiment of the present invention may include adjusting volume of the one or more other users' voices based on a user's preferences and/or distance of the user to one or more of the other users. A permissive embodiment of the present invention may include enabling the one or more users to participate in the one or more conversation subgroups simultaneously and dynamically. A permissive embodiment of the present invention may include adjusting opaqueness/transparency of one or more users' avatars in the one or more conversation subgroups not involving a user.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 illustrates an exemplary application invention environment according to at least one embodiment; and

FIG. 3 is an operational flowchart illustrating a virtual parallel conversation orientation process according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

With the rise of remote work and social distancing, collaboration, social interaction, and conversing have become increasingly popular in the metaverse. Additionally, family gatherings, social meetups, company conferences, and even classroom activities, are increasingly being held in the metaverse. The metaverse longs for a way to support real-world group gathering conversation dynamics, such as the ability for users to have both large group conversations and smaller parallel group conversations, while seemingly being able to switch back and forth between the multiple conversations while remaining in the same virtual room. For example, three friends may break away from the rest of a ten-person group to have small conversations and can concurrently listen to the large group conversation. Another example could involve persons standing next to each other and whispering to one another during a large group conversation. Thus, a seamless conversational experience that accurately replicates that of an in-person group experience is a necessity for an improved user experience in the metaverse.

In the metaverse, attempts have been made in the art to address supporting a real-world conversation experience, for instance by supporting parallel conversations in addition to a large group conversation by loading users into separate isolated rooms, or by enabling privacy settings for users' text conversations. The former current method supports parallel conversations in addition to a large group conversation, such as a conference room meeting, which involves loading users into separate isolated rooms to have their breakout conversations with certain users, thus simulating the experience of a web conference break-out room. However, this current method does not replicate how parallel conversations happen in the real world, which is as an aside from the main/larger group conversation, while remaining in the same room as the rest of the users. The current method can be uninviting to users, as they are likely to feel isolated from the other users while in separate breakout rooms. Additionally, constantly separating users into different rooms breaks up the natural flow of a conversation and thus, does not offer an accurate virtual representation of conversations in the real world. The latter current method allows users to have the contents of their text conversations obfuscated, where only users identified as having social network affiliation with the user would be able to read the text conversations. However, this current method does not replicate how parallel conversations happen in the real world either, as this method only involves text conversations and not voice conversations. Additionally, text interactions do not offer the same features as voice interactions and thus, do not offer an accurate virtual representation of conversations in the real world.

As such, it may be advantageous to, among other things, implement a system that creates and manages conversation subgroups with conversation context awareness and allows users to participate in various conversations to varying degrees with a seamless non-disruptive ability to merge in on different sub-conversations and move from one conversation to another. The present invention has the capacity to improve the metaverse by enabling users to participate in one or more conversation subgroups simultaneously and dynamically, and to join and/or switch between the conversation subgroups when appropriate. The present invention uses artificial intelligence systems in combination with a mixed reality system to provide an organic conversation dynamic for users in the metaverse that is focused on the natural flow of conversation as experienced in the real world. This improvement in parallel conversation management in the metaverse can be accomplished by implementing a system that detects differences in conversation topics between one or more users in a virtual environment, generates separate conversation subgroups based on the detected differences in the conversation topics, and groups users into the separate conversation subgroups. An embodiment in which the system enables the users to dynamically move between the conversation subgroups and participate in multiple conversation subgroups simultaneously has the advantage of further providing an organic conversation dynamic for users in the metaverse that is focused on the natural flow of conversation as experienced in the real world. An embodiment in which the system generates a visual representation customized to each participant, depicting the other users' conversation statuses and the privacy settings of the subgroups is also useful for further improving the user experience in a virtual world.

In some embodiments of the invention, the virtual parallel conversation orientation program, herein referred to as “the program”, can render a mixed reality (MR) simulated environment. The MR simulated environment, herein referred to as “the MR environment”, may be a hybrid environment comprising both physical and virtual elements. The MR environment may comprise a hybrid physical/virtual world in which one or more users may enter, see, move around in, interact with, etc. through the medium of a MR device. The users in the MR environment may be able to see and/or interact with the same virtual objects and virtual elements, and may interact with virtual representations of each other. The MR environment may comprise AR environments wherein generated images, sounds, haptic feedback, and other sensations are integrated into a real-world environment. The MR environment may comprise virtual reality (VR) environments that fully replace the physical environment with virtual elements, such that a user experiencing a VR environment cannot see any objects or elements of the physical world; however, the VR environments are anchored to real-world locations, such that the movement of the users, virtual objects, virtual environmental effects and elements all occur relative to the corresponding locations in the physical environment. The program can track the movements of the users. IoT devices, such as cameras and/or sensors, can be used to detect what actions are being performed by the users and the movement patterns of the users. For example, wearable IoT devices or movement detection sensors may be used.

The program can detect differences in the conversations between multiple participants in the MR environment. The program may monitor, understand, and display the text of conversations in the metaverse using artificial intelligence (AI) systems such as IBM Watson Studio™ (IBM Watson Studio™ and all IBM Watson Studio™-based trademarks and logos are trademarks or registered trademarks of International Business Machines Corporation, and/or its affiliates). Differences in a conversation may comprise a change in the topic of a conversation, who is being addressed in a conversation, secrecy of the material in the conversation, etc. The program may generate separate conversation subgroups based on the differences in the conversations being discussed. Once the subgroups are created, the program may group users into their subgroups. The program can track the voices of the users. IoT devices, such as microphones, can be used to convert electrical impulses into sound, such as a loudspeaker, speaker driver, and/or one or more speakers. Additionally, the program may display subtitles, using the AI system(s), to users who have subtitles enabled in their user preferences. Users can participate in several conversation subgroups simultaneously and dynamically, irrespective of any specific involvement threshold by the user. Also, a user may join and/or switch between other conversation subgroups when appropriate. The program may suggest a user join an ongoing conversation subgroup when the program detects that a certain topic is being discussed and that the certain topic might be of interest to the user based on the user's preferences. The program can initiate parallel conversation monitoring for users simultaneously involved in more than one conversation subgroup. The program can initiate parallel conversation monitoring by adjusting the volumes of one or more users' voices and/or the transparency of one or more users' avatars as needed. The program may adjust the volumes of other users' voices and/or the transparency of other users' avatars based on a user's preferences, a user's input on the program's GUI, and/or by determining the context of the conversations.

The program may monitor ongoing conversations using the AI systems and based on a user's preferences, the program may mute or turn down the audio of conversation subgroups that the user is not a part of, and/or the program may enhance the audio of the conversation subgroup(s) of which the user is participating. Also, the avatars in the conversation subgroups that the user is not a part of may appear more transparent, allowing users to identify what users are part of their conversation(s) while still being able to see the entire group of users in the virtual room.

The program may generate a visual representation depicting the other users' statuses. The visual representation may comprise the user's name, the user's title, such as IT manager, and/or what conversation subgroup(s) the user is currently in. A user may input information related to their name and title in their profile.

In some embodiments of the invention, the program may automatically provide labels or tags describing the conversation subgroup's privacy settings, such as if the conversation subgroup was public, friends only, or private, when a user looks at an avatar of another user who is part of a different conversation subgroup. The labels or tags may overlay above the avatar that the user is looking at, allowing a user to be aware of the other conversation subgroups going on in the same virtual environment as them. A user may provide additional descriptions for their conversation subgroup, such as the time period the conversation subgroup is expected to run for, which may be displayed along with the labels and tags provided by the program.

In some embodiments of the invention, the program may create customized audio settings from each user's point of view based on a user's distance from other users. The program may increase and/or decrease the volume of the other users' voices in the same conversation subgroup as the user based on the distance between the user's avatars and the other avatars. For example, an avatar standing further away from the user's avatar may have the volume of their voice lowered to a level below the volume of the voice of an avatar who is standing beside the user's avatar.

The program may comprise a virtual world knowledge corpus. The virtual world knowledge corpus can comprise historical data related to users conversing in one or more conversations, and specifically, the data from the text of the conversations. Additionally, the virtual world knowledge corpus may comprise a profile for each user. A user's profile may comprise the user's preferences for conversation subgroups in a virtual world. A user may input their preferences regarding both voice/audio and visual settings. Each user may set their preferences regarding one or more other users, such as having a specific user always muted, or having a specific user's volume always enabled and/or their avatar always opaque, even if the specific user is part of a different conversation subgroup than the user in the virtual room. A user may also set their preferences to display subtitles for conversation subgroups that the user is not a part of. A user may set up alerts so that the user is sent an invitation to join a conversation subgroup when a certain topic is being discussed, such as coding. Additionally, the virtual world knowledge corpus may comprise information related to the physical layout of real-world areas, such as a workplace, and IoT devices connected to the program. The virtual world knowledge corpus may be updated based on the continuous monitoring of conversation subgroups, and the conversations within them, in the virtual world.

An exemplary use of the invention may involve Joseph, Cindy, Bob, and Tim having a remote office meeting held in the metaverse. Bob and Tim realize that they need to finalize some details on their part of a report before presenting the report with Joseph and Cindy. Thus, Bob and Tim start a separate conversation and the program detects a change in the conversation topic and generates a separate subgroup for Bob and Tim. Meanwhile, Joseph and Cindy notice Bob and Tim's avatars turning slightly transparent. Based on Cindy's user preferences, Bob and Tim's conversation is completely muted because they are part of a different conversation subgroup, and thus, only subtitles displaying Bob and Tim's conversation are displayed for Cindy to view. Based on Joseph's user preferences, Bob and Tim's conversation is only lowered in volume and thus, Joseph can still hear Bob and Tim's conversation. Joseph and Cindy have the option to join Bob and Tim's conversation subgroup, however, they stay in the larger group and engage in small talk among themselves. Subsequently, Joseph and Cindy send a request for Bob and Tim to rejoin the larger group conversation so that the four can start presenting their report. Upon reception of the rejoin request, Bob and Tim end their conversation subgroup and rejoin the other two members of their group. Upon Bob and Tim's acceptance of the rejoin request, all avatars return to being fully opaque, and all voice volume levels are enhanced back to their initial levels.

Another exemplary use of the invention may involve Jim, Jack, and John joining an online gaming conference held in the metaverse. All the participants in the gaming conference are in the public waiting room where multiple conversations are taking place. Jim, Jack, and John choose to have a private conversation where no other participants are allowed to join and thus, are put into their own subgroup. While talking amongst themselves, Jim, Jack, and John can see the conversations of the other subgroups with the participants' avatars slightly transparent and their voices muted. They see the majority of participants gathering into one conversation and therefore, Jim, Jack, and John request to listen in on the conversation and hear the group talking about some of the latest video game demos. The three friends choose to turn up the volume on the other video game demo conversation, allowing them to listen to the conversation but still talk privately among themselves. The big group conversation starts to get more interesting as interactive games begin. The three friends decide to leave their private conversation and join the big group conversation so that they can interact and converse with the other participants in the conversation.

Another exemplary use of the invention may involve a trade show, where employees from company A are hosting an interactive information session for business partners from Company X, Company Y, and Company Z. At the interactive information session, system administrators, business administrators, and developers from the different companies are conversing with one another. The program automatically creates and segments users into conversation subgroups based on the users who are relevant to each conversation topic. Additionally, when there is confidential material to discuss for some of the present parties, such as when Company A needs to discuss an internal matter, the volume of the voices of the users in Company A are muted to all present users not employed at Company A. The subgroup conversation status is visible to other members of company A who are not involved in the conversation but can join the conversation subgroup at any time.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The following described exemplary embodiments provide a system, method, and program product to support parallel conversation management in a virtual environment by monitoring conversations between one or more users; detecting differences in the conversations between the one or more users, generating one or more conversation subgroups based on the detected differences in the conversations, and grouping the one or more users into the one or more subgroups. Additionally, the following described exemplary embodiments provide a system, method, and program product to support parallel conversation management in a virtual environment by permitting the one or more users to join and/or switch between the one or more subgroups, when appropriate.

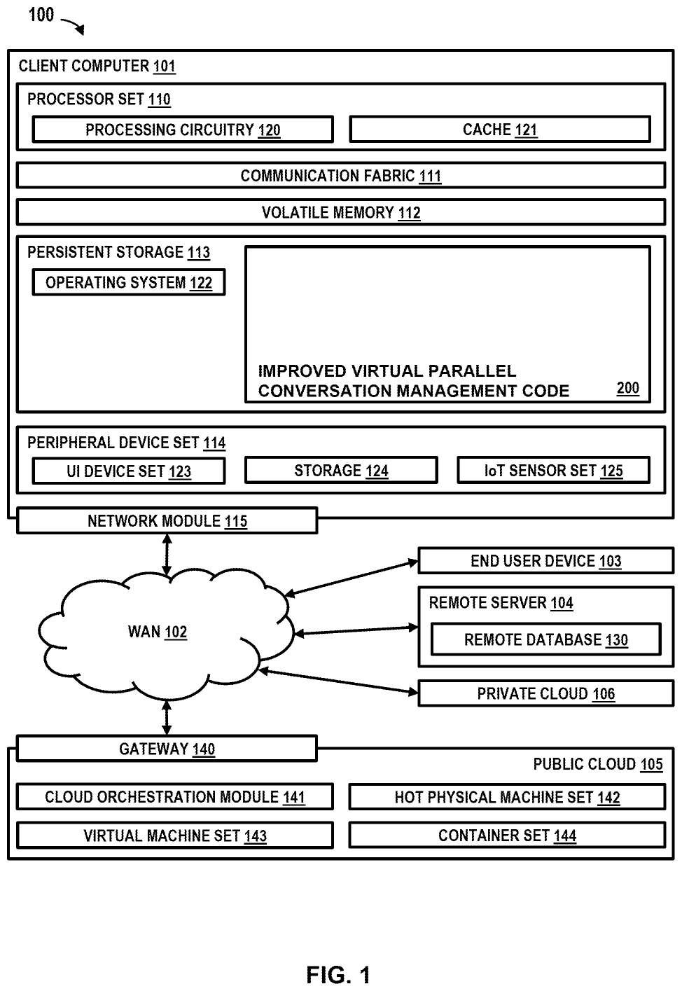

Referring to FIG. 1, an exemplary networked computer environment 100 is depicted, according to at least one embodiment. Computing environment 100 contains an example of an environment for the execution of at least some of the computer code involved in performing the inventive methods, such as improved virtual parallel conversation management code 200. In addition to code block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in code block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104. In some embodiments of the invention, remote server 104 may comprise a metaverse server 104. The metaverse server 104 hosts a simulated virtual world, or a metaverse, for a plurality of client computers 101. The metaverse server 104 enables a user on a client computer 101 to interact with other users on other client computers 101 that are also connected to the metaverse server 104. In some of the embodiments, the metaverse server 104 may be an array of servers. The metaverse server 104 may include a plurality of storage servers apart from the plurality of simulation servers, dedicated to storing data related to objects and characters in the metaverse world. The data stored on the plurality of storage servers may include object shapes, avatar shapes and appearances, audio clips, metaverse related scripts, and other metaverse related objects.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

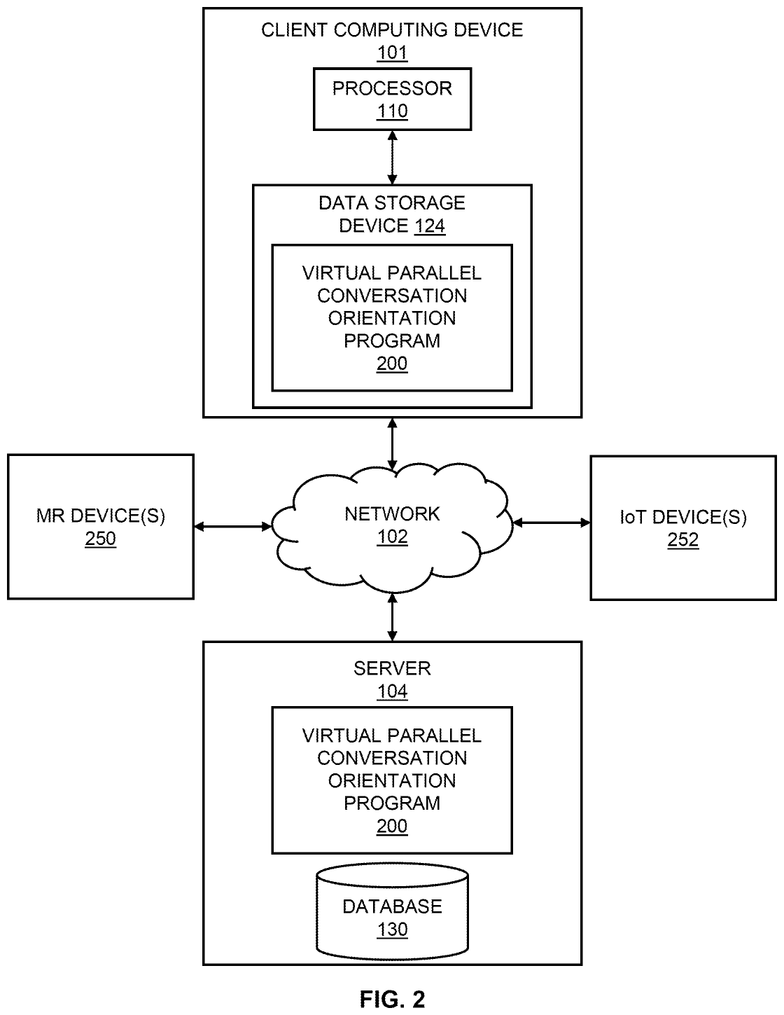

Referring to FIG. 2, an exemplary application environment is depicted, according to at least one embodiment. FIG. 2 may include client computing device 101 and a remote server 104 interconnected via a communication network 102. According to at least one implementation, FIG. 2 may include a plurality of client computing devices 101 and remote servers 104, of which only one of each is shown for illustrative brevity. It may be appreciated that FIG. 2 provides only an illustration of one implementation and does not imply any limitations with regard to the environments in which different embodiments may be implemented. Many modifications to the depicted environments may be made based on design and implementation requirements.

Client computing device 101 may include a processor 110 and a data storage device 124 that is enabled to host and run a virtual parallel conversation orientation program 200 and communicate with the remote server 104 via the communication network 102, in accordance with one embodiment of the invention.

The remote server computer 104 may be a laptop computer, netbook computer, personal computer (PC), a desktop computer, or any programmable electronic device or any network of programmable electronic devices capable of hosting and running a virtual parallel conversation orientation program 200 and a database 130 and communicating with the client computing device 101 via the communication network 102, in accordance with embodiments of the invention. The remote server 104 may also operate in a cloud computing service model, such as Software as a Service (SaaS), Platform as a Service (PaaS), or Infrastructure as a Service (IaaS). The remote server 104 may also be located in a cloud computing deployment model, such as a private cloud, community cloud, public cloud, or hybrid cloud.

The database 130 may be a digital repository capable of data storage and data retrieval. The database 130 can be present in the remote server 104 and/or any other location in the network 102. The database 130 may comprise a virtual world knowledge corpus. The virtual world knowledge corpus can comprise historical data related to users conversing in one or more conversations, and specifically, the data from the text of the conversations. Additionally, the virtual world knowledge corpus may comprise a profile for each user. A user's profile may comprise the user's preferences for conversation subgroups in the virtual world and information relating to the user, such as the user's name, the user's job title, or topics of conversation that the user is interested in, etc. A user may input their preferences regarding both voice/audio and visual settings. Each user may set their preferences regarding one or more other users, such as having a specific user always muted, or having a specific user's volume always enabled and/or their avatar always opaque, even if the specific user is part of a different conversation subgroup than the user in the virtual room. A user may also set their preferences regarding displaying subtitles for conversation subgroups that the user is not a part of. A user may set up alerts so that the user is sent an invitation to join a conversation subgroup when a certain topic, such as coding, is being discussed. Additionally, the virtual world knowledge corpus may comprise information related to the physical layout of real-world areas, such as a workplace, and IoT devices 252 connected to the program 200. The virtual world knowledge corpus may be updated based on the continuous monitoring of conversation subgroups, and the conversations within them, in the virtual world.

Mixed reality (MR) device(s) 250 may be any device or combination of devices enabled to record-world information that the MR module 402 may overlay with computer-generated perceptual elements to create a MR environment. The MR device 250 can record the actions, position, movements, etc. of a user, to track the user's movement within and interactions with the MR environment. The MR device 250 can display a MR simulated environment to a user and allow the user to interact with the MR environment. The MR device 250 can be a headset. Also, the MR device 250 can comprise a head-mounted display (HMD). Additionally, the MR device 250 may be equipped with or comprise a number of sensors, such as a camera, microphone, and accelerometer, and these sensors may be equipped with or comprise a number of user interface devices such as touchscreens, speakers, etc.

IoT device(s) 252 may be any device capable of tracking a user's movements. The IoT device(s) 252 can comprise cameras, such as any device capable of recording visual images in the form of photographs, films, or video signals, such as a physical or virtual camera, and/or sensors, such as accelerometers, gyroscopes, magnetometers, proximity sensors, pressure sensors, etc. Additionally, IoT device(s) 252 may be any device capable of tracking the voices of the users. IoT devices, such as microphones, can be used to convert electrical impulses into sound, such as a loudspeaker, speaker driver, and/or one or more speakers.

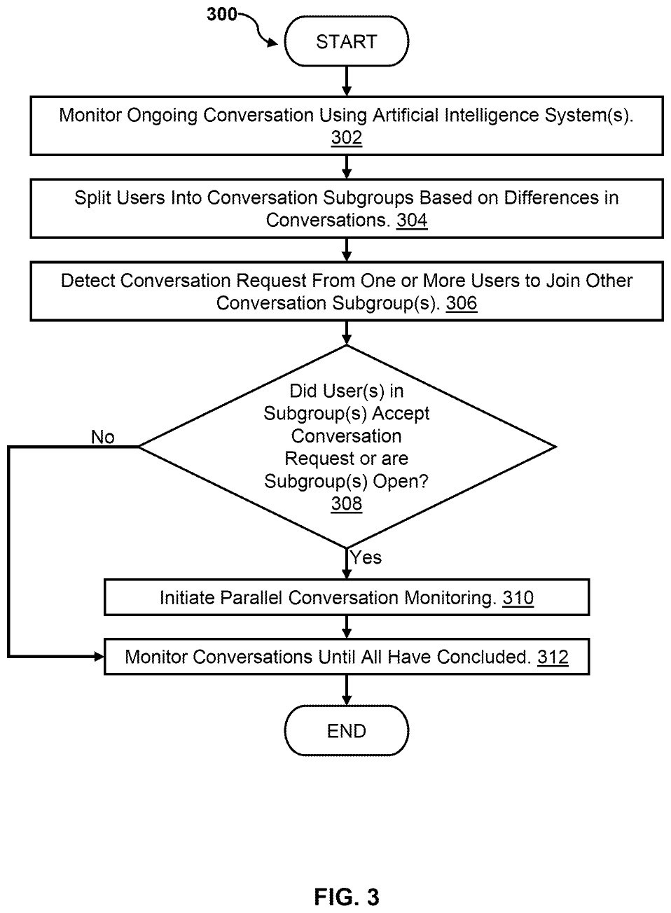

According to the present embodiment, the virtual parallel conversation orientation program 200, herein referred to as “the program”, is capable of detecting differences in conversations between one or more users in a virtual environment, generating separate conversation subgroups based on the detected differences in the conversations, grouping users into the conversation subgroups, and enabling the users to dynamically move between the conversation subgroups. The program 200 may be located on client computing device 101 or remote server 104 or on any other device located within network 102. Furthermore, the program 200 may be distributed in its operation over multiple devices, such as client computing device 101 and remote server 104. The virtual parallel conversation orientation method is explained in further detail below with respect to FIG. 3.

Referring now to FIG. 3, an operational flowchart illustrating a virtual parallel conversation orientation process 300 is depicted according to at least one embodiment. At 302, the program 200 monitors the ongoing conversations in a virtual environment between users using artificial intelligence (AI) system(s). A user may be any person using the MR device 250. The program 200 can render a mixed reality (MR) simulated environment, also referred to as a “virtual environment”. If the user is the first avatar in the virtual environment, the program 200 may create a virtual environment or the user may use an already created virtual environment in the virtual world knowledge corpus. If the user is joining a virtual environment, the program 200 may insert the user into an already created virtual environment. The program 200 can monitor, understand, and display the text of conversations in the metaverse using artificial intelligence systems such as IBM Watson Studio™ (IBM Watson Studio™ and all IBM Watson Studio™-based trademarks and logos are trademarks or registered trademarks of International Business Machines Corporation, and/or its affiliates). The program 200 may use artificial intelligence in the understanding, derivation of meaning, and analysis of human language, by utilizing a machine learning model to ingest and analyze the data gathered by monitoring the users' voices in the virtual environment. The machine learning model may be trained to identify the context of conversations based on topic modeling on the conversation text to extract the relevant information from the text. The machine learning model may be trained on the virtual world knowledge corpus comprising historical data related to users conversing in one or more conversations, and specifically, the data from the text of the conversations. Additionally, the program 200 may display subtitles of conversations in the conversation subgroups, using the AI system(s), to other users who have subtitles enabled in their user preferences.

In some embodiments of the invention, the program 200 may generate a visual representation depicting the other users' statuses. The visual representation may comprise the user's name, the user's title, such as IT manager, and/or what conversation subgroup(s) the user is currently in. A user may input information related to their name and title in their profile. The program 200 may check a user's profile to determine what information should be displayed in the visual representation of a user.

In some embodiments of the invention, the program 200 may automatically provide labels or tags describing the conversation subgroup's privacy settings, such as if the conversation subgroup is public, friends only, or private, when a user looks at an avatar of another user who is part of a difference conversation subgroup. The program 200 may determine a conversation subgroup's privacy settings based on information within the virtual world knowledge corpus relating to the type of conversation subgroup and/or from a user's input on the program's 200 graphical user interface (GUI). The labels or tags may overlay above the avatar that the user is looking at. A user may provide additional descriptions for their conversation subgroup, such as the time period the conversation subgroup is expected to run for, which the program 200 may display along with the other labels and tags.

At 304, the program 200 splits users into subgroups based on the differences in the conversations. Using the AI systems, the program 200 may determine the different conversations happening in the virtual environment and create subgroups for each of the users based on the differences in the conversations. Differences in a conversation may comprise a change in the topic of a conversation, who is being addressed in a conversation, secrecy of the material in the conversation, etc. For example, if there is a group of 4 users in a virtual environment and persons A and B are discussing accounting, and persons C and D are discussing coding, the program 200 may recognize that there are two distinct topics of conversation currently happening and thus, generate two separate conversation subgroups. Additionally, a user may input that a separate conversation is occurring, or going to occur, input the users who will/may be a part of that separate conversation, and request the creation of a subgroup, using the program's 200 GUI. Once the subgroups are created, the program 200 may group the users into their subgroups. Continuing with the previous example, the program 200 may group users A and B in subgroup one and group users C and D in subgroup two.

In some embodiments of the invention, the program 200 may suggest a user join an ongoing conversation subgroup when the program 200 detects that a certain topic is being discussed and that the certain topic might be of interest to the user based on the user's preferences. A user may set up alerts so that the user is sent an invitation to join a conversation subgroup when a certain topic, such as coding, is being discussed.

At 306, the program 200 detects a conversation request from one or more users to join a conversation subgroup. A user may request to join another conversation subgroup using the program's 200 GUI. Additionally, a user may request another user join their conversation subgroup. The program 200 may detect a conversation request based on the inputs of one or more users using the program's 200 GUI. Users can participate in several conversation subgroups simultaneously and dynamically, irrespective of any specific involvement threshold by the user. Also, a user may join and/or switch between other conversation subgroups when appropriate.

Then, at 308, the program 200 determines if one or more users in the requested subgroup(s) accepted the conversation request or if the subgroup(s) are open to joining. The program 200 may check a conversation subgroup's privacy settings to determine if the subgroup is open, friends only, or private. If the subgroup is open, the program 200 may let any user join the subgroup. If the subgroup is private, the program 200 may send a conversation request to the users in the subgroup and display a prompt to the users in the subgroup asking them to confirm whether the requesting user may join the conversation subgroup. If one or more users in the subgroup respond to the prompt allowing the requesting user, the program 200 may insert the user into the subgroup. However, if the users in the subgroup(s) decline and/or do not respond to the program's 200 conversation request, the program 200 may not insert the user into the subgroup. If a user is invited to join a conversation subgroup and accepts the request, the program 200 may insert the user into the subgroup. According to one implementation, if the program 200 determines that one or more users in the other subgroup(s) accepted the conversation request or that the subgroup(s) are open to join (step 308, “YES” branch), the program 200 may continue to step 310 to initiate parallel conversations for users simultaneously in more than one conversation subgroup. If the program 200 determines that one or more users in the other subgroup(s) did not accept the conversation request or that the subgroup(s) are private (step 308, “NO” branch), the program 200 may continue to step 312 to monitor all conversation until all of the conversations have concluded.

At 310, the program 200 initiates parallel conversation monitoring for users simultaneously involved in more than one conversation subgroup. The program 200 initiates parallel conversation monitoring by adjusting the volumes of one or more users' voices and/or the transparency of one or more users' avatars as needed. The program 200 may adjust the volumes of other users' voices and/or the transparency of other users' avatars based on a user's preferences, a user's input on the program's 200 GUI, and/or by determining the context of the conversations, for example, who a user is talking to and/or which users are talking to a user.

In some embodiments of the invention, the program 200 may monitor ongoing conversations using the AI systems, and based on a user's preferences, the program 200 may mute or turn down the audio of conversation subgroups that the user is not a part of, and/or the program 200 may enhance the audio of the conversation subgroup(s) of which the user is participating. Also, the program 200 may increase the transparency of the avatars of users in the conversation subgroups that the user is not a part of based on a user's preferences.

In some embodiments of the invention, the program 200 may create customized audio settings from each user's point of view based on a user's distance from other users. The program 200 may increase and/or decrease the volume of the other users' voices in the same conversation subgroup as the user based on the distance between the user's avatars and the other avatars. For example, an avatar standing further away from the user's avatar may have the volume of their voice lowered to a level below the volume of the voice of an avatar who is standing beside the user's avatar.

At 312, the program 200 monitors all conversation subgroups in the virtual environment until all the conversations have concluded. The program 200 can determine that all conversations have concluded when all users in the virtual environment exit the virtual environment or when the program 200 no longer detects voice input from the users in the virtual environment.

It may be appreciated that FIGS. 2 through 3 provide only an illustration of one implementation and do not imply any limitations with regard to how different embodiments may be implemented. Many modifications to the depicted environments may be made based on design and implementation requirements.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

1. A processor-implemented method for parallel conversation management in a virtual environment, the method comprising:
monitoring one or more users and their conversations in the virtual environment using one or more Internet of Things (IoT) devices and one or more mixed reality (MR) devices;
detecting differences in the conversations between the one or more users, wherein detecting the differences in the conversations comprises determining one or more contexts of the conversations;
generating one or more conversation subgroups based on the detected differences in the conversations, wherein the detected differences in the conversations comprise a change in a topic of a conversation or a secrecy of material of a conversation; and
grouping the one or more users into the one or more conversation subgroups based on the detected differences in the conversations.

2. The method of claim 1, further comprising:
displaying at least one customized visual representation to the one or more users depicting one or more other users' statuses and/or privacy settings of conversation subgroups.

3. (canceled)

4. The method of claim 1, further comprising:
permitting the one or more users to switch between the one or more conversation subgroups simultaneously and dynamically; and
initiating parallel conversation monitoring for one or more users simultaneously involved in more than one conversation subgroup.

5. The method of claim 4, wherein the parallel conversation monitoring for the one or more users simultaneously involved in more than one conversation subgroup comprises adjusting volume of the one or more other users' voices based on a user's preferences, distance of the user to one or more of the other users, and the determined context of the one or more conversations.

6. The method of claim 1, further comprising:
sending, dynamically, an invite to the one or more users to join one or more conversation subgroups based on the determined context of the one or more conversations.

7. The method of claim 5, wherein the parallel conversation monitoring for the one or more users simultaneously involved in more than one conversation subgroup further comprises adjusting opaqueness/transparency of one or more users' avatars in the one or more conversation subgroups based on the determined context of the one or more conversation subgroups.

8. A computer system for parallel conversation management in a virtual environment, the computing system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
monitoring one or more users and their conversations in the virtual environment using one or more Internet of Things (IoT) devices and one or more mixed reality (MR) devices;
detecting differences in the conversations between the one or more users, wherein detecting the differences in the conversations comprises determining one or more contexts of the conversations;
generating one or more conversation subgroups based on the detected differences in the conversations, wherein the detected differences in the conversations comprise a change in a topic of a conversation or a secrecy of material of a conversation; and
grouping the one or more users into the one or more conversation subgroups based on the detected differences in the conversations.

9. The computing system of claim 8, further comprising:
displaying at least one customized visual representation to the one or more users depicting one or more other users' statuses and/or privacy settings of conversation subgroups.

10. (canceled)

11. The computing system of claim 8, further comprising:
permitting the one or more users to switch between the one or more conversation subgroups simultaneously and dynamically; and
initiating parallel conversation monitoring for one or more users simultaneously involved in more than one conversation subgroup.

12. The computing system of claim 11, wherein the parallel conversation monitoring for the one or more users simultaneously involved in more than one conversation subgroup comprises adjusting volume of the one or more other users' voices based on a user's preferences, distance of the user to one or more of the other users, and the determined context of the one or more conversations.

13. The computing system of claim 8, further comprising:
sending, dynamically, an invite to the one or more users to join one or more conversation subgroups based on the determined context of the one or more conversations.

14. The computing system of claim 12, wherein the parallel conversation monitoring for the one or more users simultaneously involved in more than one conversation subgroup further comprises adjusting opaqueness/transparency of one or more users' avatars in the one or more conversation subgroups based on the determined context of the one or more conversation subgroups.

15. A computer program product for parallel conversation management in a virtual environment, the computer program product comprising:
one or more computer-readable tangible storage medium and program instructions stored on at least one of the one or more tangible storage medium, the program instructions executable by a processor to cause the processor to perform a method comprising:
monitoring one or more users and their conversations in the virtual environment using one or more Internet of Things (IoT) devices and one or more mixed reality (MR) devices;
detecting differences in the conversations between the one or more users, wherein detecting the differences in the conversations comprises determining one or more contexts of the conversations;
generating one or more conversation subgroups based on the detected differences in the conversations, wherein the detected differences in the conversations comprise a change in a topic of a conversation or a secrecy of material of a conversation; and
grouping the one or more users into the one or more conversation subgroups based on the detected differences in the conversations.

16. The computer program product of claim 15, further comprising:
displaying at least one customized visual representation to the one or more users depicting one or more other users' statuses and/or privacy settings of other conversation subgroups.

17. (canceled)

18. The computer program product of claim 15, further comprising:
permitting the one or more users to switch between the one or more conversation subgroups simultaneously and dynamically; and
initiating parallel conversation monitoring for one or more users simultaneously involved in more than one conversation subgroup.

19. The computer program product of claim 18, wherein the parallel conversation monitoring for the one or more users simultaneously involved in more than one conversation subgroup comprises adjusting volume of the one or more other users' voices based on a user's preferences, distance of the user to one or more of the other users, and the determined context of the one or more conversations.

20. The computer program product of claim 15, further comprising:
sending, dynamically, an invite to the one or more users to join one or more conversation subgroups based on the determined context of the one or more conversations.

21. The method of claim 19, wherein the parallel conversation monitoring for the one or more users simultaneously involved in more than one conversation subgroup further comprises adjusting opaqueness/transparency of one or more users' avatars in the one or more conversation subgroups based on the determined context of the one or more conversation subgroups.

22. The method of claim 1, further comprising:
recognizing that there are one or more distinct topics of conversation occurring concurrently; and
generating two or more separate conversation subgroups based on the one or more distinct topics of conversation occurring concurrently.
